(19) United States
(12) Patent Application Publication
(10) Pub. No.: US 2013/0136189 A9
(43) Pub. Date: May 30, 2013

(54) METHOD AND SYSTEM FOR CONVERTING A DSS STREAM TO AN ENCRYPTED MPEG STREAM

(71) Applicant: Jiang Fu, San Diego, CA (US)

(72) Inventor: Jiang Fu, San Diego, CA (US)

(21) Appl. No.: 11/733,967

(22) Filed: Apr. 11, 2007

Related U.S. Application Data
(63) Continuation-in-part of application No. 10/341,704, filed on Jan. 13, 2003, now Pat. No. 7,499,469.

(51) Int. Cl. H04B 1/66

(52) U.S. Cl. 375/240.26; 375/E07.026

(57) ABSTRACT

Aspects of a method and system for converting a DSS stream to an encrypted MPEG stream are provided. In some applications, for example, an access device such as a set-top box may require the conversion of DSS proprietary transport streams to standardized MPEG transport streams in order to communicate with an external MPEG device, such as a personal computer. In this regard, conversion of a DSS stream to a MPEG stream may require the conversion of DSS formatted timing/synchronization information into MPEG formatted timing/synchronization information. Additionally, some applications may require the converted MPEG stream to be encrypted utilizing AES counter encryption. In this regard, when converting the DSS stream to an MPEG stream, the data may need to be packetized appropriately to enable the AES counter encryption.

### CROSS-REFERENCE TO RELATED APPLICATIONS/INCORPORATION BY REFERENCE

Not applicable

### FIELD OF THE INVENTION

Certain embodiments of the invention relate to digital communications. More specifically, certain embodiments of the invention relate to a method and system for converting DSS timing information to MPEG timing information.

### BACKGROUND OF THE INVENTION

The introduction of broadband networks, access devices such as set-top boxes, and media such as DVD disks recorded with digitally compressed audio, video and data signals, for example, which utilize motion Picture Expert Group (MPEG) compression protocols, may provide sound and picture quality that is virtually indistinguishable from the original material. The MPEG protocols such as MPEG-2, provides the necessary protocols and infrastructure that may be used for transferring digitally compressed audio, video and data signals over various media. A detailed description of the MPEG-2 standard is published as ISO/IEC Standard 13818-2. As broadband networks continue to evolve, there is a need to provide access for legacy devices to ensure interoperability with legacy and disparate systems.

Satellite based systems have been utilized for decades to provide point-to-multipoint communications. Satellite based systems generally include an earth station which transmits microwave signals to an orbiting satellite. The orbiting satellite may be adapted to receive the microwave signals from the earth station, amplify the received microwave signals and transmit resulting amplified signals back towards earth or other orbiting satellites. In this regard, the satellite is adapted to function as a repeater and/or signal regenerator. Although satellites have been around for decades, the lack of standardized communication technologies, compounded with factors such as signal latency, high cost and immunity to atmospheric interference have resulted in low market penetration. Notwithstanding, advancements and standardization in satellite based communication technologies have created new opportunities that will result in greater market penetration. For example, advancements in open standards such as digital video broadcast (DVB) satellite standards and DVB data standard for Internet protocol (IP) have created opportunities for the efficient communication of streaming media to remote sites located throughout the globe.

The existence of proprietary and standardized satellite communication technologies provides a need for concurrent support of proprietary systems, legacy systems and/or systems that utilize the standardized communication technologies. For example, DirecTV which broadcasts digital television (DTV) programs utilizes a proprietary direct satellite system (DSS) transport stream, which has a packet format of 130 bytes per packet, including prefix and payload bytes. Today's standardized set-top boxes are designed to support DVB standard MPEG transport streams and do not provide support for the 130 bytes per packet DSS proprietary transport stream.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and method is provided for converting a DSS stream to an encrypted MPEG stream, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is diagram illustrating an exemplary MPEG transport stream in connection with an embodiment of the invention.

FIG. 1B is a diagram of the structure for an exemplary MPEG transport packet, in connection with an embodiment of the invention.

FIG. 2 is diagram illustrating an exemplary DSS transport packet, in connection with an embodiment of the invention.

FIG. 3 is a block diagram of an exemplary system that may enable conversion of a DSS stream into an encrypted MPEG stream, in accordance with an embodiment of the invention.

FIG. 4A is a diagram illustrating the packetization of an access unit to enable AES counter mode encryption, in accordance with an embodiment of the invention.

FIG. 4B is a diagram illustrating an exemplary transport packet that may enable transmission of a first ‘N’ data bytes of an access unit in a system utilizing AES counter mode encryption, in accordance with an embodiment of the invention.

FIG. 4C is a diagram illustrating a plurality of exemplary transport packets that may enable the transmission of a first ‘N’ data bytes of an access unit in a system utilizing AES counter mode encryption, in accordance with an embodiment of the invention.

### DETAILED DESCRIPTION OF THE INVENTION

Certain embodiments of the invention may be found in a method and system for converting a DSS stream to an encrypted MPEG stream. Given the current mixture of standardized, proprietary and legacy technologies in satellite communications systems, conversion methodologies may be required to provide device compatibility and interoperability. In some applications, for example, an access device such as a set-top box may require the conversion of DSS proprietary transport streams to standardized MPEG transport streams in order to communicate with an external MPEG device, such as a personal computer. In this regard, conversion of a DSS stream to a MPEG stream may require the conversion of DSS formatted timing/synchronization information into MPEG formatted timing/synchronization information. Additionally, some applications may require the converted MPEG stream to be encrypted utilizing AES counter encryption. In this regard, when converting the DSS stream to an MPEG stream, the data may need to be packetized appropriately to enable the AES counter encryption.

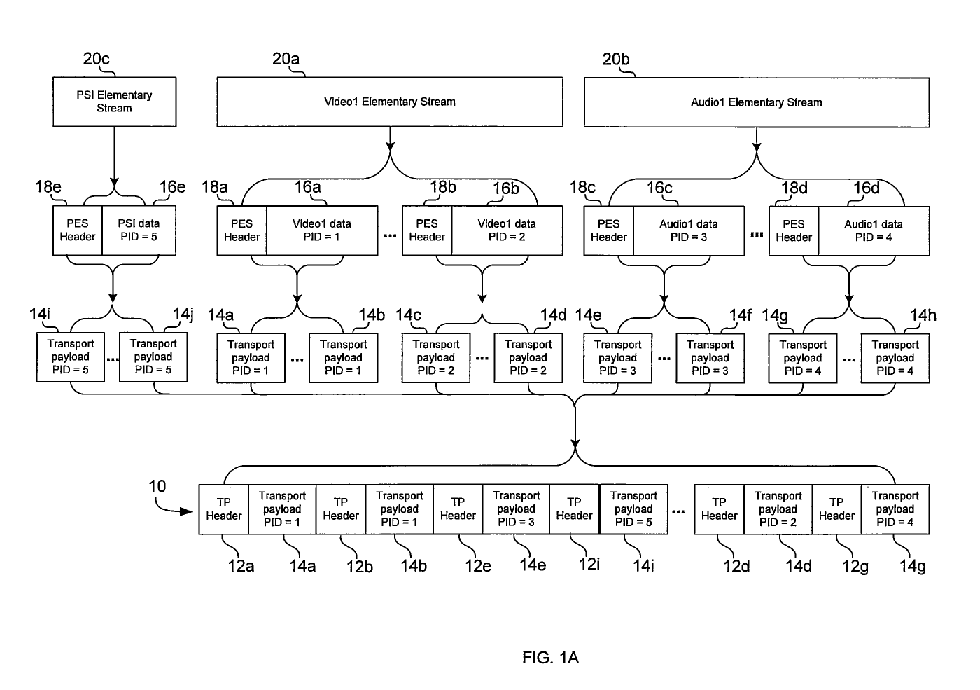

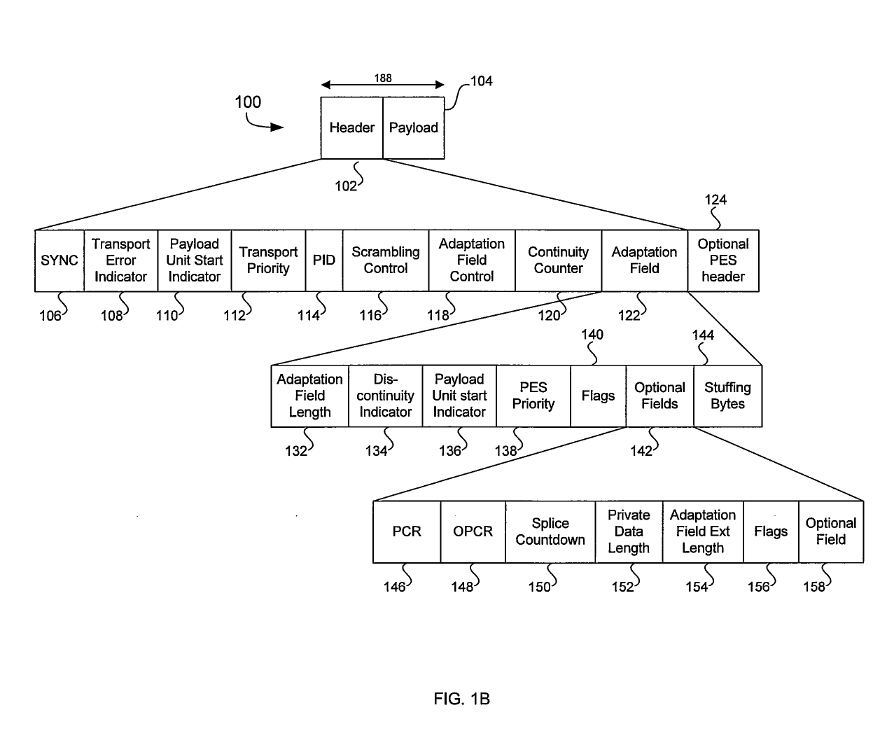

FIG. 1A is diagram illustrating an exemplary MPEG transport stream in connection with an embodiment of the invention. Referring to FIG. 1A, the transport stream (TS) 10 may comprise one or more transport packets with headers 12 and payloads 14. The transport packets may be created utilizing information comprising a header 18 and payload 16 of one or more Packetized elementary streams (PES), which, in turn, may be created utilizing information comprising one or more elementary streams 20.

The MPEG encoder may be configured to apply MPEG compression algorithms to the source content, which may result in an individual compressed ES for each audio and video stream. The ES data may be organized into access units which may represent a fundamental unit of encoding such as a video frame or multiple audio frames. This encoded and compressed data stream may be decoded in a set-top box and viewed on a TV. Factors such as a bit rate of the encoded stream, quality of the original source content and encoder algorithm may typically determine the quality of the output signal. Notably, the type of encoding may determine whether another system will be able to decode and interpret a received MPEG data stream. In this regard, the other system may be a legacy or disparate system.

In a typical MPEG data stream, the length of individual ESs 18 may be equivalent to the length of the program. Each ES 18 may comprise a plurality of variable-length PES. The PES may comprise a header that may precede one or more payload bytes. The PES may comprise an integral number of access units. The PES header 18 may include information pertaining to the encoding process required by the MPEG decoder to decompress and decode a received ES. Each individual ES may have a corresponding PES and any encoded audio and video information may still reside in separate PESs. Notably, the PES may be viewed primarily as a logical construct and is not intended to be utilized for data interchange, transport, and interoperability. Notwithstanding, the PES may be utilized for conversion between transport streams (TSs) and program information streams (PSs).

The TS and PS may be formed by multiplexing a plurality of packets. The TS may include a plurality of additional packets that may contain tables, which may be utilized for de-multiplexing the TS. The tables may be collectively called program specific information (PSI). To maintain synchronization and timing, null packets may also be inserted to fill the intervals between information-bearing packets. These null packets may contain dummy payload data and timing information for their associated program. The timing information may be called the program clock reference (PCR). The PCR may be located in one of the optional header fields of the TS packet. During operation, the PCR may permit the decoder to synchronize its clock to the same frequency as that of the original encoder's clock frequency. The MPEG transport packets may have a fixed length of 188 bytes, which may include a header having a minimum size of 4 bytes and a maximum payload of 184 bytes.

FIG. 1B is a diagram of the structure for an exemplary MPEG transport packet 100. Referring to FIG. 1B, the transport packet 100 may include a header 102 and payload 104. The header 102 may comprise a synchronization (SYNC) byte 106, a transport error indicator 108, a payload unit start indicator 110, a transport priority 112, a packet ID (PID) 114, a transport scrambling control 116, an adaptation field control 118, a continuity counter 120, an adaptation field 122, and an optional PES header 124. The adaptation field 122 may comprise the following fields: adaptation field length 132, discontinuity indicator 134, random access indicator 136, PES priority 138, flags 140, optional fields 142 and stuffing bytes 144. The optional fields 142 may comprise the following: program clock reference (PCR) 146, OPCR 148, a splice countdown 150, private data length 152, adaptation field extension length 154, flags 156 and optional field 158.

The transport packet (TP) 100 may comprise a variable length PES header 124. In this regard, the information comprising the TP header is additional to the PES header information. The SYNC byte 106 may be used to delineate the beginning and ending of the TP 100. The transport error indicator 108 may indicate when there is an error in a packet or block and may be particularly useful for error block testing. The PID 114 may be a unique identifier that may identify every PES. The PID 114 may be utilized for identifying a channel and may include any information required for locating, identifying and reconstructing programs. Some PIDs are reserved for specific uses by the MPEG protocol. The PID values may be stored in PSI tables. In order to ensure that all the audio, video and data for a program are properly decoded, it may be critical to ensure that the PIDs are correctly assigned and that the PSI tables correspond with their associated audio and video streams.

The PCR 146 may have 42 bits, 9 bits of which may be incremented at 27 MHz and 33 bits that may be incremented at 90 kHz (upon rollover of the 9 bits). The bits in the PCR 146 may provide program clock recovery information that may be utilized for synchronization. The PCR 146 may be used to provide a clock recovery mechanism for MPEG programs. A 27 MHz system time clock (STC) signal may typically be used for encoding MPEG signals. Decoding of the signal requires a clock that may be locked to the encoder's STC of 27 MHz. Notably, the PCR 146 may be utilized by the decoder to regenerate a local clock signal that is locked to the STC. Whenever a program is placed in the transport stream, a 27 MHz time stamp may be inserted into the PCR 146. When the signal is received by a decoder, the decoder may compare the value in the PCR 146 with the frequency of its local voltage controlled oscillator (VCO) and adjust the VCO to ensure that the VCO is locked to the frequency specified by the PCR 146. To ensure accuracy, the PCR 146 may be updated with the STC every about 100 ms.

The packet 104 may comprise multimedia information such as data, video and its corresponding audio, for example, that may need to be synchronized to a time reference such as the PCR. In this manner, the packet may comprise a presentation time stamp (PTS) and/or a decode time stamp (DTS) which the receiver may utilize to determine the order in which to decode incoming data and the order in which to present the decoded data.

The continuity counter (CC) 120 may be used to determine when packets are lost or repeated. It may include a 4-bit field, which may be repeatedly incremented from zero to 15 for each PID. Discontinuity counter 134 may permit a decoder to handle discontinuities in the transport stream. Discontinuity counter 134 may indicate time base, such as the PCR 146 and/or continuity counter 120, discontinuities. The payload unit start indicator 136 may be configured to indicate whether a TP is the start of a PES. The splice countdown 150 may be configured to indicate the end of an access unit and may be utilized to determine where the video may be spliced to another video source without disrupting the video.

Two or more MPEG TSs may be multiplexed to form a multi-program Transport Stream (MPTS). In a case where the TS may include a single MPEG TS, the output of the multiplexer may be called a single program TS (SPTS). Furthermore, a number of SPTSs may be multiplexed to create a MPTS. In some cases, the program may include one or more ESs that may have a similar time reference. This may occur, for example, in a movie that has video and its corresponding audio content.

The PSI may include a set of tables that may be part of a TS. The tables in the PSI may be required while de-multiplexing the TS and for matching PIDs to their corresponding programs. Once the PIDs are matched to their corresponding programs, the TS may be decoded by assembling and decompressing program contents. Typically, in order to determine which audio and video PIDs contain the corresponding content for a particular program, a program map table (PMT) may be decoded. Each program may have its own PMT bearing a unique PID value. The program association table (PAT) may be decoded in order to determine which PID contains the desired program's PMT. The PAT may function as the master PSI table with PID value always equal to 0×0. In a case where the PAT cannot be found and decoded in the TS, no programs may be available for presentation.

The program specific information (PSI) table may be refreshed periodically at a rate that is fast enough to allow a set-top box to go through program recovery and decompression processes. This may be necessary to ensure real-time user interaction. The PSI may also be used to determine the accuracy and consistency of PSI contents. Notwithstanding, during programs changes or modification of multiplexer provisioning, there may be packets which have a PID value present in the TS, but have no corresponding reference in the PSI. Additionally, the PSI may have references to one or more packets in the PID that are not present in the TS.

In existing MPEG compliant systems, audio/video services may be carried using some or all of the 188 bytes of the transport packets. Multiple services may be differentiated using a packet identifier (PID) contained in a packet header called the transport packet header. Transport packets from various services may be multiplexed and transmitted on the same physical medium. Exemplary media may include, copper, coaxial cable, wireless, optical and any combination thereof. On the receiver side transport packets may be de-multiplexed and data may be separated for each service. For example, audio packets may be separately de-multiplexed from video packets.

Transport packets may include three fields, namely a 4-byte header, an optional adaptation field and a packet payload. The packet payload may not be altered by multiplexing or transmitting equipment, except during processing which may include data encryption and decryption. In general, encryption may be done once within a typical MPEG processing system. Notwithstanding, some information comprising the adaptation field may be changed by multiplexing and transmission equipment. Typically, packet order within a PID channel may be maintained from an MPEG encoder to an MPEG receiver but packet order among multiple PID streams may not be guaranteed during transmission by any transmitting equipment. In cases where co-relation of packets from different PIDs may be required, packet position in a stream cannot be utilized since packet order among multiple PID channels may be altered.

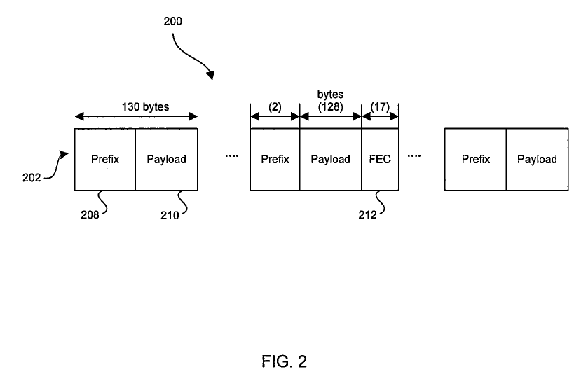

FIG. 2 is block diagram illustrating a portion of an exemplary DSS transport stream 200 comprising an exemplary DSS transport packet 202, in connection with an embodiment of the invention. Referring to FIG. 2, there is shown a DSS transport packet 202. The DSS transport packet 202 may include a prefix portion 208 and a payload portion 210. The prefix portion 208 of the DSS transport packet 202 may contain two (2) bytes, while the payload portion 210 may contain 128 bytes. The DSS transport packet 202 may have 130 bytes per packet. An additional seventeen bytes following the end of the payload portion may be utilized for forward error correction (FEC) 212. The two (2) byte prefix may include a 12-bit service channel identification (SCID) 214, which may be adapted to define one of channels 0 through 4095 to which a packet may belong. The SCID 214 may be analogous to the PID 114 (FIG. 1) of an MPEG frame. Following the SCID 214, various flag fields may define a type of encryption utilized by the packet. Each flag may be four (4) bits.

The packet 202 may be an auxiliary packet which may enable the transmission of timing/synchronization information. In this regard, the packet 202 may comprise a reference time stamp (RTS). The RTS may comprise a 32-bit value and may be based on a 27 MHz system clock. The function of the RTS in a DSS transport stream may be analogous to the function of the PCR in an MPEG transport stream. However, the implementation of the RTS and PCR may be different. In this regard, converting a DSS transport stream to a MPEG transport stream may require converting the RTS to a PCR.

The packet 202 may comprise multimedia information such as data and/or video and its corresponding audio, for example, which may require synchronization to some time reference such as the RTS. In this regard, the packet 202 may comprise a presentation time stamp (PTS) and/or a decode time stamp (DTS), which the receiver may utilize to determine the order in which to decode incoming data and the order in which to present the decoded data. The PTS/DTS in a DSS transport stream may be functionally equivalent to the PTS/DTS in a MPEG transport stream. However, the implementations may be different. In this regard, converting a DSS transport stream to an MPEG transport stream may require converting the DSS formatted PTS/DTS to a MPEG formatted PTS/DTS.

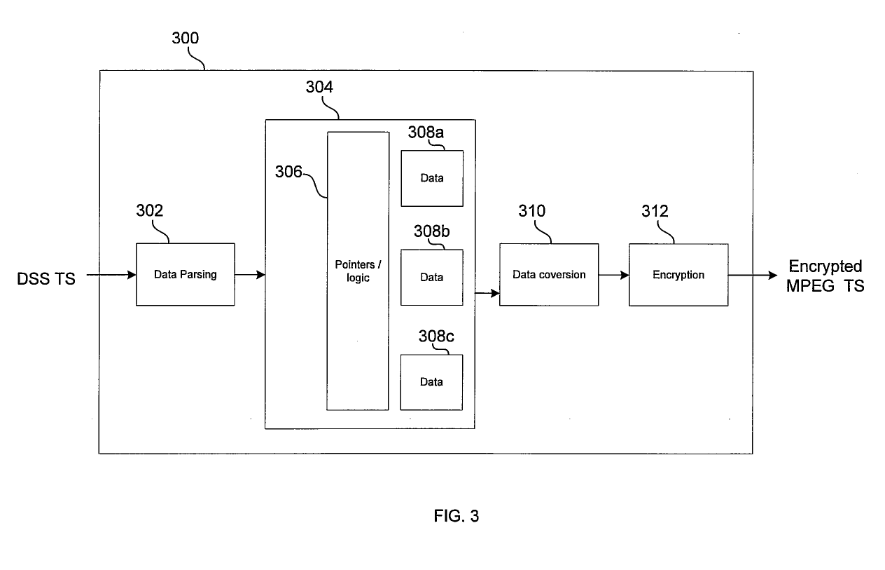

FIG. 3 is a block diagram of an exemplary system that may enable conversion of a DSS stream into an encrypted MPEG stream, in accordance with an embodiment of the invention. Referring to FIG. 3, the system 300 may comprise a data parsing block (302), a buffer (304), a data conversion block 310, and an encryption block 312. In various embodiments of the invention, the data parsing block 302, the data conversion block 310, and the encryption block 312 may comprise functions implemented by a single processor or each block may comprise one or more processors.

The data parsing block 302, may comprise suitable logic, circuitry, and/or code that may enable parsing incoming DSS streams and outputting of the information to a buffer such as the buffer 302. In various aspects of the invention, the data parsing block 302 may enable identification of the information in the incoming stream and may enable storing the information to the buffer 302 accordingly. For example, the data parsing block 302 may enable identification of information such as header information, audio data, video data, PSI, and RTS, and may enable storing the information in a determined order and location in the buffer 304. In this regard, the data parsing block 302 may enable storing of video data to one location in buffer 304 and may enable storing the header information associated with the video data to another location in the buffer 304. The data parsing block 302 may enable storing supplemental information pertaining to the parsed DSS information to buffer 304. In this regard, the data parsing block 302 may populate a table in buffer 304 that identifies a location that is a start and end address in buffer 304, for one or more received packets in the incoming DSS stream. The data parsing block 302 may identify a data type such as video, audio, and/or PSI for one or more received packets in the incoming DSS stream. The data parsing block 302 may identify a block of header information, for example, PID, PTS/DTS, for one or more received packets in the incoming DSS stream. In various embodiments of the invention, the data parsing block 320 may be implemented in one or more processors.

The buffer 304 may comprise at least one pointer/logic block 306 and at least one data block 308. In this regard, the buffer 304 may comprise one or more memory blocks, such as a DRAM, for example. The logic/pointer block 306 may comprise suitable logic, circuitry, and/or code that may enable finding information in, retrieving information from, and/or storing information to the at least one data block 308. In this manner, the at least one pointer/logic block 306 may comprise addressing logic for a memory cell. The at least one pointer/logic block 306 may comprise a table comprising pointers and/or information pertaining to the information stored in the at least one data block 308. In this regard, a first data block may comprise raw data from a packet and a second data block may comprise supplemental/header information from the packet.

The encryption block 312 may comprise suitable logic, circuitry, and/or code that may enable AES counter mode encryption of information stored in the buffer 304.

The data conversion block 310 may comprise suitable logic, circuitry, and/or code that may enable retrieving information from the buffer 304 and may enable packetizing this information into MPEG transport packets. In this regard, the data conversion block 304 may enable the creation of MPEG packets such as the packet 100 in FIG. 1B.

In operation, a DSS transport stream 200 may arrive at the system 300. The DSS transport stream 200 may comprise audio, video, and/or PSI information, for example. The data may be parsed by the data parsing block 302 and may be stored into one or more data blocks in the buffer 304.

The data conversion block 310 may comprise suitable logic, circuitry and/or code that may enable conversion from DSS formatting to MPEG formatting and may enable packetizing the converted information to generate one or more MPEG transport streams. In this regard, the data conversion block 310 may enable identifying, finding, and/or retrieving information in the buffer 304 to identify one or more access units (AUs). The data conversion block 310 may enable identifying, finding, and/or retrieving information in the buffer 304 to generate one or more MPEG PESs. The data conversion block 310 may also enable identifying, finding, and/or retrieving information in the buffer 304 to generate one or more MPEG TSs.

In generating the one or more PESs, and/or TSs, the data conversion block 310 may enable the conversion of DSS formatted timing information (RTS, PTS/DTS) to MPEG formatted timing information (PCR, PTS/DTS). In this regard, the RTS may be a 32-bit value based on 27 MHz system clock and the MPEG PCR may be a 42-bit value based on 27 MHz system clock. The PCR may be carried in a, for example, a 33-bit base together with a 9-bit extension. Due to the bit length difference, additional data processing may be needed when RTS value loops around.

In one embodiment of the invention, the system 300 may store a PCR state value. The Initial PCR value may be set when a first RTS is received in the incoming DSS stream. The PCR may be updated each time a new RTS is received. The PCR increment may be based on the difference between successively received RTS values. When the RTS loops around from (2³²−1) to 0, the PCR increment may be based on the difference between the successively received RTS values, plus a (2³²−1) offset. Accordingly, since PTS/DTS is based on the original RTS, the system 300 may utilize a similar procedure to increment the MPEG PTS/DTS by the difference in successively received RTS values, plus a 2³² offset in the event of the RTS looping around from (2³²−1) to 0. Additionally, due to frame re-ordering, the PTS/DTS value may loop around from 0 to (2³²−1) in which instance the MPEG PTS may be incremented by the difference in successively received RTS/DTS values, minus a (2³²−1) offset.

In another embodiment of the invention, the system 300 may not need to store an additional PCR state. In this regard, each RTS value may be treated as a PCR value and may be utilized as a PCR packet directly. Accordingly, when the RTS loops around, one or more control bits, such as the CC 120 and/or the discontinuity indicator 134, as described in FIG. 1B, may be set in the corresponding MPEG transport packet. Accordingly, since PTS/DTS is based on the original RTS, the system 300 may utilize a similar procedure of utilizing the DSS PTS/DTS value as a MPEG PTS/DTS value directly and setting the discontinuity indicator 134 in the corresponding MPEG transport packet when the DSS formatted PTS/DTS loops around.

Aspects of the invention may enable detecting the RTS loop around by comparing two successively received RTS values. In accordance with an embodiment of the invention, the PTS/DTS loop around may be detected by comparing two successively received PTS/DTS values. In this manner, if the current (newer of the two) RTS (PTS/DTS) values is larger than the preceding RTS (PTS/DTS) value, and the difference between the two RTS (PTS/DTS) values is larger than a pre-determined threshold, then loop around from 0 to (2³²−1) may have occurred. If the current (newer of the two) RTS (PTS/DTS) values is smaller than the preceding RTS (PTS/DTS) value, and if the difference between the two RTS (PTS/DTS) values is larger than a predetermined threshold, then loop around may have occurred. The value of the threshold may have a minimum value of 2̂31, for example. Additionally, the RTS and/or PTS/DTS value does not have to be exactly equal to 0 and/or (2³²−1) for loop around to occur. For example, loop around may have occurred when a first RTS has a value of 2³¹ and an immediately subsequent RTS has a value of 10.

In certain embodiments of the invention, the data conversion block 310 may identify one or more access units in the buffer 304. The data conversion block 310 may enable the packetization, utilizing DSS to MPEG converted timing information, of each access unit into one or more PESs. The data conversion block 310 may further enable the packetization, utilizing DSS to MPEG converted timing information, of one or more PESs into one or more MPEG transport packets (TPs). The data conversion block 310 may also enable formatting the TPs such that they may be encrypted utilizing AES counter mode encryption.

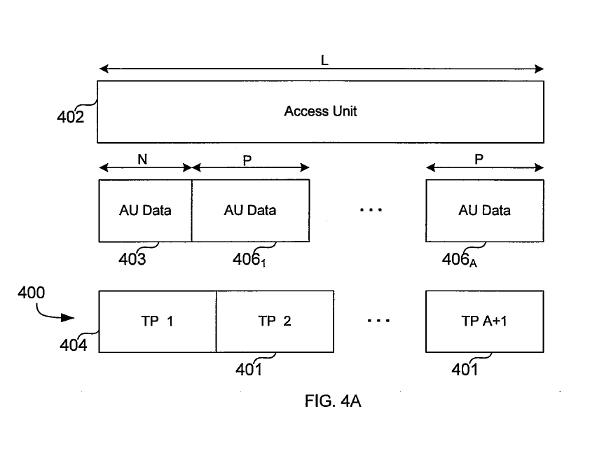

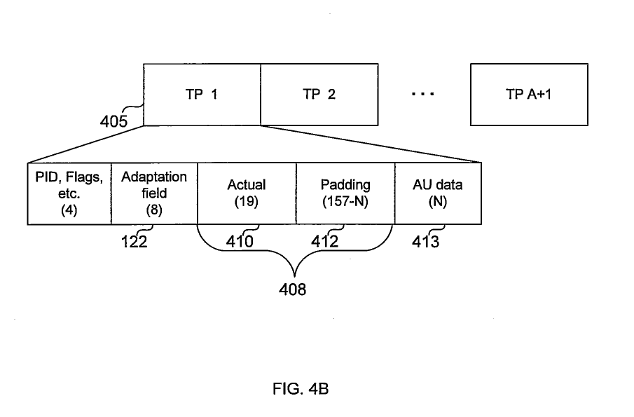

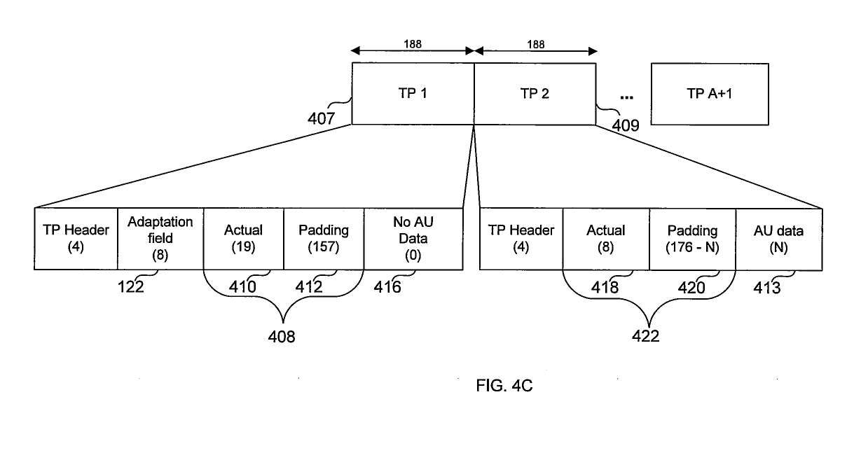

FIG. 4 is a diagram of a MPEG transport stream which may enable AES counter mode encryption of variable length access units (AUs) in accordance with an embodiment of the invention. Referring to FIG. 4 is shown an access unit 402, and a transport stream 400. The access unit 402 may be divided into a data chunk 403 and one or more data chunks 406₁, . . . , 406_{A}. The transport stream 400 may comprise a number, A+1, of transport packets.

In various embodiments of the invention, a start of each access unit may be aligned to a start of a packetized elementary stream (PES). In this manner, the payload of a first MPEG transport packet 404 subsequent to the start of a new access unit may comprise up to 19 bytes of PES header information.

The access unit 402 may comprise a number of bytes L which may be defined according to the following equation 1,

L=A×P+N EQ. 1

where ‘A’ is an integer, ‘X’ is a cipher block size, ‘P’ is an integer multiple of ‘X’, and ‘N’ is a non-integer multiple of ‘X’. In this manner, ‘A’ may represent the number of data chunks 406 with length ‘P’, while ‘N’ may represent the length of the data chunk 403. Aspects of the invention may enable encapsulating the data chunks 403, 406₁, . . . , 406_{A} into one or more MPEG transport packets and may enable encryption of one or more of the transport packets utilizing AES counter mode encryption. In this regard, a payload of each of the MPEG transport packets 401 may comprise one of data chunks 406₁, . . . , 406_{A}, which have lengths P and thus may be encrypted directly. However, since ‘N’ is not a multiple of ‘X’, a packet such as the MPEG TP 404, comprising a payload of data chunk 403, may not be directly encrypted utilizing AES counter mode encryption. Accordingly, padding bytes may be inserted in a payload portion of the TP 404 such that the data block 403 plus padding has a length that may be equal to ‘P’. However, this solution may be unacceptable since prepending or appending padding bytes to access unit data may cause, for example, an MPEG audio decoder to lose sync. Accordingly, alternative methods of transmitting the TP 404, comprising a payload of ‘N’ bytes, may be necessary and the method of transmitting it may be determined by the value of ‘N’.

FIG. 4B is a diagram illustrating a MPEG transport packet that may enable transmission of a first ‘N’ data bytes of an access unit in a system utilizing AES counter encryption, in accordance with an embodiment of the invention. Referring to FIG. 4B, the MPEG TP 405 may comprise an adaptation field 122, a PES header 408, and a block of AU data 413.

The adaptation field 122 may be as described in FIG. 1B. In an exemplary embodiment of the invention, the length of the adaptation field 122 may be equal to 184−‘P’. For example, if ‘X’ is 16 bytes and ‘P’ is 176 bytes, the adaptation field may be 8 bytes. The PES header 408 may comprise up to 19 bytes of actual header information 410 and may comprise a number of padding bytes 412. The number of padding bytes 412 may be determined by the value of ‘N’. For example, if ‘X’ is 16 bytes, ‘P’ is 176 bytes, and ‘N’ is 100 bytes, then the number of padding bytes may be 176−19−100=57 bytes. In this manner, when ‘N’+19 is less than ‘P’, the data chunk 403 of FIG. 4A, may be encapsulated into a transport packet containing a PES header. The PES header may be padded with ‘P’−‘N’−19 additional bytes such that the total length of the packet may be 188 bytes. Accordingly, the block of AU data 413 may be a ‘N’ byte chunk of access unit data.

FIG. 4C is a diagram illustrating a plurality of MPEG transport packets 407 and 409 that may enable transmission of a first ‘N’ data bytes of an access unit in a system utilizing AES counter encryption, in accordance with an embodiment of the invention. Referring to FIG. 4C, the MPEG TP 407 may be similar to the MPEG TP 404 of FIG. 4B, with a difference being that TP 407 may comprise no AU data bytes and thus no payload. In this regard, the TP 407 may have one or more flags set to indicate that there is no payload. Accordingly, the number of padding bytes in the PES header may be larger than in the TP 405, such that the total packet length is still 188 bytes.

The MPEG TP 409 may comprise an adaptation field 422 and a block of AU data 413. The adaptation field 422 may comprise 8 bytes of actual adaptation field information 418 and may comprise a number of padding bytes 420. In this regard, the number of padding bytes 420 may be equal to ‘P’−‘N’. In an exemplary embodiment of the invention, if ‘P’ is 176 and N is 170, then 6 padding bytes may be inserted in the adaptation field 422. In this manner, when ‘N’+19 is greater than ‘P’, the TP 407 may comprise only PES header information and PES header padding bytes while the payload of the TP 409 may comprise the first ‘N. bytes of AU data. In this regard, the payload 413 may comprise the first data sent subsequent to PES header information and may thus be transmitted unencrypted. In various embodiments of the invention, any number of bytes may be inserted between the packet comprising the PES header and the packet comprising the first payload of access unit data. Additionally, when ‘N’+19 is less than ‘P’ as in the case described in FIG. 4B, various embodiments of the invention may packetize the information as in FIG. 4C.

Aspects of the invention may be found in a method and system for converting at least a portion of a DSS transport stream, such as the stream 200 in FIG. 2, to at least a portion of a MPEG transport stream, such as the stream 10 in FIG. 1A. In this regard, the conversion may comprise mapping one or more RTS values to one or more PCR values and/or mapping one or more DSS formatted PTS/DTS values to one or more MPEG formatted PTS/DTS values.

In various embodiments of the invention, one or more RTS values may be mapped to one or more PCR values by initializing a first PCR value to a received RTS value. Additionally, the one or more PCR values may be incremented by a difference between a current received RTS value and an immediately previous received RTS value. Also, aspects of the invention may enable detecting when the RTS value has looped around by determining if the difference between successively received RTS values is greater than a threshold. Accordingly, when the current RTS value loops around, an offset may be added to the PCR value.

In various embodiments of the invention, one or more RTS values may be utilized as one or more PCR values. Additionally, when one or more RTS values loop around, aspects of the invention may enable modifying more or more control bits in the at least a portion of a MPEG transport stream.

In various embodiments of the invention, one or more DSS formatted PTS/DTS values may be mapped to one or more MPEG formatted PTS/DTS values by initializing a first MPEG formatted PTS/DTS value to a received DSS formatted PTS/DTS value. Additionally, the MPEG formatted PTS/DTS value may be incremented by a difference between a current received DSS formatted PTS/DTS value and an immediately previous received DSS formatted PTS/DTS value. Also, aspects of the invention may enable detecting when the DSS formatted PTS/DTS value has looped around by determining if the difference between successively received DSS formatted PTS/DTS values is greater than a threshold. Accordingly, when the current DSS formatted PTS/DTS value loops around, an offset may be added to the MPEG formatted PTS/DTS value.

In various embodiments of the invention, one or more DSS formatted PTS/DTS values may be utilized as one or more MPEG formatted PTS/DTS values. Additionally, one or more of the DSS formatted PTS/DTS values loop around, aspects of the invention may enable modifying more or more control bits in the at least a portion of a MPEG transport stream.

The conversion of at least a portion of a DSS transport stream to at least a portion of a MPEG transport stream may comprise packetizing one or more access units comprising the received DSS transport stream into one or more MPEG transport packets, as shown in FIG. 4A, such that the MPEG transport packets may be encrypted, utilizing, for example, AES counter mode encryption. In this regard, aspects of the invention may enable determining the remainder of a division of a number of bytes comprising an access unit by a block size of a block cipher, and a number of payload data bytes equal to this remainder may be placed into a first MPEG transport packet comprising a PES header, as shown in the MPEG transport packet 405 of FIG. 4B. Additionally, this first MPEG transport packet may remain unencrypted. Also, aspects of the invention may enable placing a number of payload data bytes into a second MPEG transport packet when a first MPEG transport packet comprising a PES header comprises no payload data bytes, as shown by the MPEG transport packets 407 and 409 of FIG. 4C. Additionally, these first two MPEG transport packets may remain unencrypted.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for signal processing, the method comprising:
receiving a DSS transport stream;
converting at least a portion of said received DSS transport stream to at least a portion of an MPEG transport stream, wherein said converting comprises one or both of:
mapping one or more RTS values in said DSS transport stream to one or more corresponding PCR values in said MPEG transport stream; and
mapping one or more DSS formatted PTS/DTS values in said DSS stream to one or more corresponding MPEG formatted PTS/DTS values in said MPEG transport stream.

2. The method according to claim 1, comprising initializing a first of said one or more corresponding PCR values to a corresponding received RTS value.

3. The method according to claim 2, comprising incrementing a current PCR value by an amount equal to a difference between a current received RTS value and a immediately previous received RTS value.

4. The method according to claim 3, comprising adding an offset to said incremented current PCR value when said current RTS value loops around.

5. The method according to claim 3, comprising determining when said current RTS value loops around by determining whether said difference is greater than a threshold value.

6. The method according to claim 1, comprising initializing a first of said one or more MPEG formatted PTS/DTS values to a received DSS formatted PTS/DTS value.

7. The method according to claim 1, comprising incrementing a current MPEG formatted PTS/DTS value by an amount equal to a difference between a current received DSS formatted PTS/DTS value and an immediately previous received DSS formatted PTS/DTS value.

8. The method according to claim 7, comprising adding an offset to said incremented current MPEG formatted PTS/DTS value when said current received DSS formatted PTS/DTS value loops around.

9. The method according to claim 7, comprising determining when said current received DSS formatted PTS/DTS value loops around by determining whether said difference is greater than a threshold value.

10. The method according to claim 1, comprising utilizing said one or more RTS values as said corresponding one or more PCR values.

11. The method according to claim 1, comprising modifying one or more control bits in said at least a portion of said MPEG transport when said one or more DSS formatted PTS/DTS values loops around.

12. The method according to claim 1, comprising utilizing said DSS formatted PTS/DTS values as said corresponding MPEG formatted PTS/DTS values.

13. The method according to claim 1, comprising modifying one or more control bits in said at least a portion of said MPEG transport stream when said DSS formatted PTS/DTS values loop around.

14. The method according to claim 1, comprising packetizing one or more access units in said at least a portion of said DSS transport stream into one or more corresponding MPEG transport packets such that one or more of said corresponding MPEG transport packets may be encrypted.

15. The method according to claim 14, comprising encrypting said one or more corresponding MPEG transport packets using AES counter mode encryption.

16. The method according to claim 14, comprising placing in an MPEG transport packet comprising a PES header, remaining payload data bytes resulting from a division of a number bytes comprising said one or more access units by a block size of a block cipher utilized for said encryption.

17. The method according to claim 16, wherein said MPEG transport packet comprising a PES header is unencrypted.

18. The method according to claim 14, comprising placing in a second MPEG transport packet remaining payload data bytes resulting from a division of a number of bytes comprising said one or more access units by a size of a cipher block utilized for said encryption, wherein no payload data is placed in a corresponding first MPEG transport packet comprising a PES header.

19. The method according to claim 18, wherein said first MPEG transport and said second MPEG transport packet are unencrypted.

20. A system for signal processing, the system comprising:
one or more processors that enable receiving a DSS transport stream; and
said one or more processors converts at least a portion of said received DSS transport stream to at least a portion of an MPEG transport stream, wherein said converting comprises one or both of:
mapping one or more RTS values in said DSS transport stream to one or more corresponding PCR values in said MPEG transport stream; and
mapping one or more DSS formatted PTS/DTS values in said DSS stream to one or more corresponding MPEG formatted PTS/DTS values in said MPEG transport stream.

21. The system according to claim 20, wherein said one or more processors enable initializing a first of said one or more corresponding PCR values to a corresponding received RTS value.

22. The system according to claim 21, wherein said one or more processors enable incrementing a current PCR value by an amount equal to a difference between a current received RTS value and a immediately previous received RTS value.

23. The system according to claim 22, wherein said one or more processors enable adding an offset to said incremented current PCR value when said current RTS value loops around.

24. The method according to claim 22, wherein said one or more processors enable determining when said current RTS value loops around by determining whether said difference is greater than a threshold value.

25. The system according to claim 20, wherein said one or more processors enable initializing a first of said one or more MPEG formatted PTS/DTS values to a received DSS formatted PTS/DTS value.

26. The system according to claim 20, wherein said one or more processors enable incrementing a current MPEG formatted PTS/DTS value by an amount equal to a difference between a current received DSS formatted PTS/DTS value and an immediately previous received DSS formatted PTS/DTS value.

27. The system according to claim 26, wherein said one or more processors enable adding an offset to said incremented current MPEG formatted PTS/DTS values when said current DSS formatted PTS/DTS values loops around.

28. The system according to claim 26, wherein said one or more processors enable determining when said current DSS formatted PTS/DTS value loops around by determining whether said difference is greater than a predetermined threshold value.

29. The system according to claim 20, wherein said one or more processors enable utilizing said one or more RTS values as said corresponding one or more PCR values.

30. The system according to claim 20, wherein said one or more processors enable modifying one or more control bits in said at least a portion of said MPEG transport when said one or more DSS formatted PTS/DTS values loops around.

31. The system according to claim 20, wherein said one or more processors enable utilizing said DSS formatted PTS/DTS values as said corresponding MPEG formatted PTS/DTS values.

32. The system according to claim 20, wherein said one or more processors enable modifying one or more control bits in said at least a portion of said MPEG transport stream when said DSS formatted PTS/DTS values loop around.

33. The system according to claim 20, wherein said one or more processors enable packetizing one or more access units in said at least a portion of said DSS transport stream into one or more corresponding MPEG transport packets such that one or more of said MPEG transport packets may be encrypted.

34. The system according to claim 33, wherein said one or more processors enable encrypting said one or more corresponding MPEG transport packets using AES counter mode encryption.

35. The system according to claim 33, wherein said one or more processors enable placing in an MPEG transport packet comprising a PES header, remaining payload (data) bytes resulting from a division of a number bytes comprising said one or more access units by a block size of a block cipher utilized for said encryption.

36. The system according to claim 35, wherein said MPEG transport packet comprising a PES header is unencrypted.

37. The system according to claim 33, wherein said one or more processors enable placing in a second MPEG transport packet remaining payload data bytes resulting from a division of a number of bytes comprising said one or more access units by a size of a cipher block utilized for said encryption, wherein no payload data is placed in a corresponding first MPEG transport packet comprising a PES header.

38. The system according to claim 37, wherein said first MPEG transport and said second MPEG transport packet are unencrypted.
